(19) United States
(12) Patent Application Publication
(10) Pub. No.: US 2015/0379544 A1
(43) Pub. Date: Dec. 31, 2015

(54) METHOD AND SYSTEM FOR REWARDING REFERRALS

(71) Applicant: REFERME HOLDINGS PTY LTD, Warranwood, Victoria (AU)

(72) Inventor: Steven MATEJKA, Warranwood, Victoria (AU)

(73) Assignee: REFERME HOLDINGS PTY LTD, Warranwood, Victoria (AU)

(21) Appl. No.: 14/765,093

(22) PCT Filed: Jan. 28, 2014
(86) PCT No.: PCT/AU2014/000046

§ 371 Date: Jul. 31, 2015

(30) Foreign Application Priority Data
Jan. 31, 2013 (AU) 2013900305

(51) Int. Cl. G06Q 30/02; G06F 17/30

(52) U.S. Cl. CPC G06Q 30/0214; G06Q 30/0233; G06F 17/30368; G06F 17/30528; G06F 17/30876

(57) ABSTRACT

A referral reward program between a merchant, a primary customer and a referred customer comprises providing a database for storage of customer account records, issuing a customer identifier code, and storing details of the primary customer in a customer account record in association with the customer identification code. The primary customer is issued with at least one referral token associated with the merchant. The token has a corresponding referral reward code, which is associated with the primary customer account record in the database. The primary customer may subsequently pass the token on to the referred customer who, in turn, presents the token to the merchant. The referral reward code provided by the referred customer is received and used to retrieve the associated primary customer account record. The primary customer account record is updated to apply a referral reward credit subsequently redeemable with the merchant by the primary customer.

### FIELD OF THE INVENTION

The present invention relates generally to purchaser incentive and rewards redemption (‘customer loyalty’) programs and, more specifically, to improvements in such programs which provide incentives for the referral of new customers.

### BACKGROUND OF THE INVENTION

Customer loyalty programs are operated in a variety of industries to aid in increasing business and improving customer relationships. Generally, such programs reward customers for repeat business with the same merchant or service provider, by awarding reward points which are subsequently redeemable in a number of ways, such as in the form of discounts and/or additional goods and services. The reward points are typically calculated using a predetermined formula or ratio relating to the customer's purchase volume. For example, in the retail industry points may be awarded on a one-for-one basis with each dollar that the customer spends on goods or services, whereas in the airline industry it is common for reward points to be awarded according to a more complex formula, incorporating distance and category of travel.

The broad objective of all customer loyalty programs is to provide an incentive which is designed to encourage customers to conduct business preferentially with one organisation rather than with competitor organisations.

A disadvantage of conventional customer loyalty programs is that customers may only earn incentives when they themselves make a purchase. There are, however, other ways in which loyal customers may contribute to business growth, such as by referring new customers, e.g. acquaintances, friends and family, to an organisation.

Methods are known for providing existing customers with rewards for referring new business to an organisation. For example, members of organisations such as health clubs may be offered rewards, such as membership discounts, for referring new members to the organisation. These types of incentive are generally effective due to the pre-existing membership basis of the business. A referred customer is able to provide the details of an existing member who provided the referral when signing up for their own membership. Since the existing member is already recorded in the organisation's systems, it is then possible to provide the referring member with an associated reward.

Existing referral reward methods have a number of disadvantages which prevent them from being applied in industries, such as retail sales, in which the relationship between a merchant and a customer is less formal. In the retail context, customers are not generally required to sign up for ‘membership’ prior to making purchases. Furthermore, the referral mechanism described above, which involves provision of existing member details along with new member details when a referred customer signs up, is unduly cumbersome, and generally impractical, in the context of industries such as retail sales, in which the relationship between a business and its customers, including even relatively loyal customers, is of a more casual nature.

There is, accordingly, a need for an improved customer loyalty program which is able to reward customers for referrals of business, as well as for their own purchases, while being simple and efficient to operate, even within relatively casual contexts such as the retail sales industry. It is also desirable that such a program should integrate with a business's existing point-of-sale (POS) systems, and provide added value to a merchant by enabling tracking and analysis of the performance of the loyalty program.

The present invention therefore seeks to address these needs.

### SUMMARY OF THE INVENTION

In one aspect, the invention provides a method of operating a referral reward program between a merchant, a primary customer and a referred customer, the method comprising steps of:

providing a database for storage of customer account records;

issuing to the primary customer a customer identifier code, and storing details of the primary customer in a customer account record in the database in association with the customer identification code;

issuing to the primary customer at least one referral token associated with the merchant, the token having a corresponding referral reward code;

associating the referral reward code with the primary customer account record in the database;

subsequently receiving the referral reward code provided by the referred customer;

using the referral reward code to retrieve the associated primary customer account record; and

updating the primary customer account record to apply a referral reward credit subsequently redeemable with the merchant by the primary customer.

Advantageously, the method provides a mechanism for tracking referrals to the merchant by the primary customer, and for rewarding the primary customer for successful referrals. In particular, when the primary customer refers a new customer, such as an acquaintance, friend or relative, to the merchant, the primary customer provides a referral reward code to the referred customer. The referred customer, in turn, provides the referral reward code to the merchant, and the code is used to identify the primary referring customer. Therefore the associations created in the database between the merchant, the referral reward code and the primary customer enable the provision of an improved customer loyalty program in which customers may be rewarded for the business that they refer to the merchant, as well as for their own purchases.

A member token may be issued to the primary customer, wherein the member token is associated with the customer identifier code. In some embodiments, the member token is a card, such as a plastic, wallet-sized, card. The customer identifier code may be recorded on the card, in human-readable form (such as a string of digits) or in machine readable form, such as a bar code or QR-code. Alternatively, or additionally, the code may be recorded magnetically or electronically in the card.

In alternative embodiments, the member token may be a digital object suitable for storage and display on a mobile device of the primary customer, and the customer identifier code is stored in the member token digital object. For example, the member token may comprise a data structure including a visual and/or alphanumeric representation of the customer identifier code, and may optionally be encrypted for transmission and storage. The data structure may be stored on a mobile device, such as a smart phone, and may be received, decoded, displayed and/or transmitted, as required, by a mobile application installed on the device.

The referral token may be a card, and the referral reward code may be recorded on or in the referral token card. Due to the disposable nature of referral tokens, it is advantageous for the referral token to be made of a material such as stiff paper or cardboard, and the referral reward code simply printed on the card.

In alternative embodiments, the referral token may be a digital object suitable for storage and display on a mobile device of the primary customer and/or the referred customer, and the referral reward code may be stored in the member token digital object. For example, the referral token may comprise a data structure including a visual and/or alphanumeric representation of the referral reward code, and may optionally be encrypted for transmission and storage. The data structure may be stored on a mobile device, such as a smart phone, and may be received, decoded, displayed and/or transmitted, as required, by a mobile application installed on the device. For example, the referral token data structure may be transmitted by the primary customer to the referred customer via any suitable messaging format supported by the mobile device, such as MMS or email.

The referral reward code may be provided by the referred customer presenting the referral token to the merchant. In some embodiments, the merchant provides a referred customer benefit, such as a discount on an initial purchase, to the referred customer. Advantageously, the provision of a referred customer benefit will tend to increase the proportion of referred customer who act on referrals from the primary customer.

The method may further include deactivating the referral reward code within the database to prevent reuse.

The database may be further provided for storage of merchant account records, and the method may further comprise:

associating the customer identifier code of the primary customer in the database with a merchant account record of the merchant; and

maintaining records of customer activity with the merchant in the merchant account record.

When the primary customer redeems the referral reward credit, the redemption may be recorded in the database.

Advantageously, maintaining records of customer activities enables the merchant to obtain detailed analyses of customer activities, and of the performance of the referral reward program.

In another aspect the invention provides a computer-implemented system for operating a referral reward program between a merchant, a primary customer and a referred customer, the system comprising:

at least one microprocessor;

at least one non-volatile storage device containing a database for storage of customer account records;

at least one computer-readable memory device operatively associated with the microprocessor; and

at least one user input device operatively associated with the microprocessor,

wherein the memory device contains computer executable instruction code which, when executed by the microprocessor, cause the microprocessor to effect a method comprising steps of:
receiving a customer identifier code issued to the primary customer, and receiving and storing details of the primary customer in a customer account record in the database in association with the customer identification code;
receiving a referral reward code corresponding with at least one referral token associated with the merchant, wherein a referral token corresponding with the referral reward code has been issued to the primary customer;
associating the received referral reward code with the primary customer account record in the database;
subsequently receiving the referral reward code provided by the referred customer;
using the referral reward code to retrieve the associated primary customer account record; and
updating the primary customer account record to apply a referral reward credit subsequently redeemable with the merchant by the primary customer.

The computer executable instruction code may further cause the microprocessor to effect a step of deactivating the referral reward code within the database to prevent reuse.

The database may be further provided for storage of merchant account records, and the computer executable instruction code may further cause the microprocessor to effect steps of:

associating the customer identifier code of the primary customer in the database with a merchant account record of the merchant; and

maintaining records of customer activity with the merchant in the merchant account record.

In some embodiments, the computer executable instruction code further causes the microprocessor to effect the step, when the primary customer redeems the referral reward credit, of recording the redemption in the database.

Further features and benefits of the invention will be apparent from the following description of embodiments, which is provided by way of example only and should not be taken to limit the scope of the invention as it is defined in any of the preceding statements, or in the claims appended hereto.

### BRIEF DESCRIPTION OF THE DRAWINGS

Embodiments of the invention will now be described with reference to the accompanying drawings, in which like reference numerals refer to like features, and wherein:

FIG. 1 is a block diagram illustrating a networked system within which embodiments of the present invention may be implemented;

FIG. 2 is a block diagram showing further details of the referral reward system server of FIG. 1;

FIG. 3 is a flowchart illustrating a process followed when a merchant is dealing with a new customer according to an embodiment of the invention;

FIG. 4 is a flowchart illustrating a customer sign-up process according to an embodiment of the invention;

FIG. 5 is a flowchart illustrating a process for issuing referral tokens according to an embodiment of the invention;

FIG. 6 is a flowchart illustrating a process for a referred customer redeeming a reward according to an embodiment of the invention;

FIG. 7 is a flowchart illustrating a merchant sign-up process according to an embodiment of the invention;

FIG. 8 is a flowchart illustrating a member token supply process according to an embodiment of the invention;

FIG. 9 is a flowchart illustrating a process for supply of new referral tokens according to an embodiment of the invention;

FIG. 10 is a screen display illustrating customer type analytics according to an embodiment of the invention;

FIG. 11 is a display screen which shows analytics for customer sales value on a daily basis according to an embodiment of the invention;

FIG. 12 is a display screen which provides analytics of employee sales performance according to an embodiment of the invention;

FIG. 13 is an exemplary screen used by a merchant to enroll a new customer in a referral reward program according to an embodiment of the invention;

FIG. 14 is an alternative screen used by a merchant when a first-time customer is already a member of the referral reward program;

FIG. 15 is a further alternative screen used by a merchant when a customer is already an existing and loyal customer;

FIG. 16 shows schematically a screen for use by a merchant when a new referred customer presents a referral token, according to an embodiment of the invention;

FIG. 17 shows schematically an exemplary screen corresponding to a case in which the referred customer is already a member of the referral reward program, according to an embodiment of the invention; and

FIG. 18 illustrates an exemplary screen corresponding to a case in which a referred customer is not an existing member of the referral reward program, according to an embodiment of the invention;

### DETAILED DESCRIPTION OF EMBODIMENTS

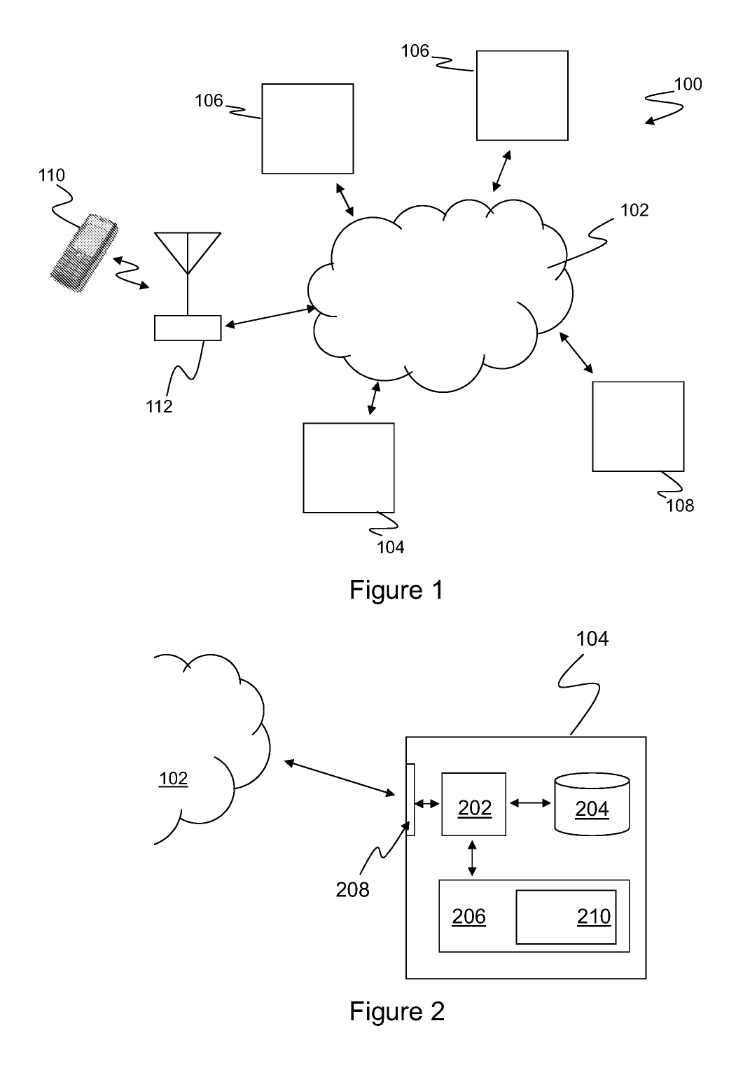

FIG. 1 is a block diagram illustrating a system 100 within which embodiments of the present invention may be implemented.

The system 100 employs a communications network 102, such as the Internet, for messaging between different components of the system, each of which generally comprises one or more computing devices.

The system 100 comprises a referral reward system server 104, one or more merchant client computers 106, and one or more customer client computers 108. In one embodiment, the referral reward system server 104 may execute a web server software application, enabling the facilities provided by the server to be delivered to the merchant client computers 106 and customer client computers 108 via conventional web browser software, thereby avoiding the need for installation of dedicated client applications on the merchant and customer computers 106, 108. In such embodiments, communications between the server 104 and the client computers 106,108 is based upon standard hypertext transfer protocol (HTTP) or, more preferably, secure hypertext transfer protocol (HTTPS) protocols. In other embodiments, however, dedicated client software applications may be developed and installed on one or more of the merchant computer systems 106 and customer computer systems 108, in which case either standard or proprietary protocols may be used for communications between the server 104 and the client systems 106, 108. All such embodiments, and variations which would be apparent to persons skilled in the relevant computer programming art, are within the scope of the present invention.

Additionally, the system 100 may comprise mobile customer terminals 110, such as smart phones, which are able to access the network 102 via wireless access points 112. The wireless access points 112 may be, for example, wireless LAN (i.e. Wi-Fi) access points, or cellular mobile access points. In some embodiments mobile browser software may be executed on the mobile device 110 in order to access services of the server 104. In other embodiments, a dedicated mobile application (‘app’) may be downloaded and installed upon the mobile device 110 to provide access to the services of the server 104. All such embodiments, and relevant variations, are within the scope of the present invention.

FIG. 2 is a block diagram showing further details of the referral reward system server 104.

The server 104 may generally comprise one or more computers, each of which includes at least one microprocessor 202. The number of computers and processors 202 generally depends upon the required processing capacity of the system, which in turn depends upon the number of client systems requiring access to the server 104. In some embodiments, a third-party cloud computing platform may be employed for implementation of the server 104, thereby enabling the physical hardware resources to be allocated, and charged, dynamically in response to client demand. However, for simplicity in the remainder of the description, it is assumed that the exemplary referral reward system server 104 includes a single computer with a single microprocessor 202.

The microprocessor 202 is interfaced to, or otherwise operably associated with, a non-volatile memory/storage device 204. The non-volatile storage 204 may be a hard disk drive, and/or may include a solid-state non-volatile memory, such as read-only memory (ROM), flash memory, or the like. The microprocessor 202 is also interfaced to volatile storage 206, such as random access memory (RAM), which contains program instructions and transient data relating to the operation of the server 104. In a conventional configuration, the storage device 204 maintains known program and data content relevant to the normal operation of the computer system, for example, the storage device 204 may contain operating system programs and data, as well as other executable application software necessary to the intended functions of the server 104. In the embodiment shown, the storage device 204 also contains program instructions which, when executed by the processor 202, enable the server computer to perform operations relating to the operation of a referral reward program embodying the invention. In operation, instructions and data held on the storage device 204 are transferred to volatile memory 206 for execution on demand.

The microprocessor 202 is also operably associated with a network interface 208 in a conventional manner. The network interface 208 facilitates access to one or more data communications networks, such as the Internet 102 employed for communication between the server 104 and merchant and customer clients 106, 108.

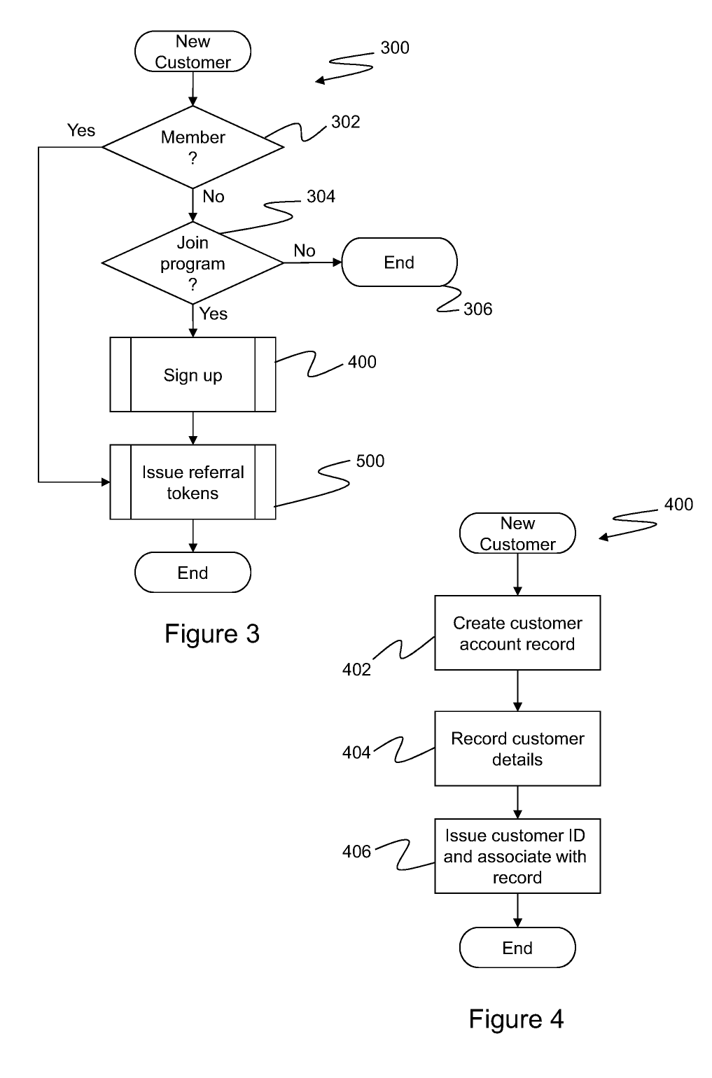

In use, the volatile storage 206 includes a corresponding body 210 of program instructions configured to perform processing and operations embodying features of the present invention, comprising various steps in the processes described below with reference to the flowcharts in FIGS. 3 to 9.

Furthermore, in the presently described embodiment, the program instructions 210 include instructions embodying a web server application. Data stored in the non-volatile 204 and volatile 206 storage, comprises web-based code for presentation and/or execution on client computers (e.g. HTML and/or JavaScript) facilitating a web-based implementation of the referral reward program accessible wholly via conventional web-browser software. However, embodiments in which portions of the executable program code are implemented within specialised applications installed on the merchant and/or customer client computers 106, 108 are also possible, and should be understood to fall within the scope of the invention.

A referral reward program embodying the invention serves to provide incentives and rewards for customers of particular businesses, such as retail outlets, not only to become repeat customers, as in a conventional loyalty program, but also to refer new customers to the business. A program embodying the invention may provide rewards to existing customers of a particular business who refer new customers, as well as providing incentives to prospective referred customers to act upon referrals, for example by offering discounts on initial purchases. In general, businesses participating in a referral reward program are identified as ‘merchants’ within this specification, while all forms of customer or client are collectively referred to as ‘customers’. These terms will be used regardless of the nature of the business, products or services operated and provided by a merchant.

Also as used within this specification, the term ‘primary customer’ refers to an existing customer of a merchant, while a ‘referred customer’ refers to a new customer, or prospective new customer, who has been referred by a primary customer.

The term ‘token’ is used to describe a physical or virtual object, such as a plastic or paper card, or a digital graphical and/or data object, which represents some form of corresponding coded identifying information.

Generally, the referral reward program, and the corresponding referral reward system server 104, is operated by a third party service provider. In this case, participating merchants sign up to the program as clients of the service provider, such that the reward system can operate across a range of competing and non-competing merchants. However, this is not the only possible implementation of the program. For example, a large department store, franchising business, or chain of outlets, may operate an in-house referral reward program in accordance with the invention. By way of example, an implementation is described herein in which a third-party referral reward program operator provides services to a range of different merchants.

According to this embodiment a merchant signs up to participate in the referral reward program, and is issued with a number of tokens, which may be plastic cards associated with individual unique identifying codes, along with a number of referral tokens, which may be paper or plastic gift cards suitable for distribution to customers.

A primary customer, i.e. an existing customer of the merchant, may be signed-up to the referral reward program and issued with one of the referral reward program tokens, whereby the unique code associated with the token (e.g. plastic card) becomes the customer identifier code for the primary customer. In terms of conventional loyalty reward programs, the customer is issued with a rewards program membership card and identifying number.

The primary customer is then also provided with a number of referral tokens, e.g. gift cards. The gift cards are associated with the merchant and the primary customer. The primary customer may then distribute the gift cards to other prospective customers, i.e. acquaintances, friends and family, to whom the primary customer wishes to refer the merchant. A referred customer may present the gift card at the merchant, in order to receive a benefit, such as a discount on a purchase. When they do so, the primary customer to whom the gift card was issued is identified, and may thereby be rewarded for the referral. For example, the primary customer may receive a credit, equivalent to a percentage of the referred customer's purchase, which is applied to the primary customer's account and which is subsequently available for review, e.g. via an on-line interface, and redemption with the merchant.

The referred customer then becomes a primary customer of the merchant. The referred customer may be an existing member of the referral reward program, or may be signed up as a new member of the program, and in either of these cases may be issued with further referral tokens, e.g. gift cards, by the merchant. Alternatively, the referred customer may decline to participate in the referral reward program, in which case no further benefits are received.

The foregoing is a basic description of the operation of an exemplary referral reward program embodying the invention. As will be appreciated, the program has a number of advantages. Firstly, it provides additional incentives for existing primary customers to refer others on to the merchant's business. Secondly, it provides incentives for the referred customers to act upon the referral. It enables records to be maintained of the primary customers, such that they may be rewarded for successful referrals. Furthermore, each referral token, e.g. gift card, is associated with a particular merchant, and, at issue, with a particular primary customer. The program may therefore be operated by a third-party service provider, so that the referral reward program may be accessed by a plurality of merchants. Each customer participant in the reward program only requires one customer identification code, and one associated program token, e.g. rewards program membership card, which can be used with all participating merchants. However, each gift card is associated with only one merchant and, once issued, with only one customer.

Yet another advantage of the program is that detailed information regarding primary customer purchases, successful referrals by primary customers, referred customer proposals, and other data relating to the operation of the merchant's business, and the effectiveness of the referral reward program, may be maintained centrally by the operator of the program, and detailed analytics made available to the merchants.

A particular implementation of the referral reward program, which may be embodied within the network system 100 shown in FIG. 1, will now be described with reference to the remaining drawings.

FIG. 3 is a flowchart 300 illustrating the process followed when a merchant is dealing with a new customer. The merchant uses a merchant computer 106 to access the referral reward system server 104, which maintains one or more databases of merchant and customer account records. For the purposes of the method 300, it is assumed that the merchant is a participant in the referral reward program, and has an established account within the referral reward system server databases.

At step 302 the merchant ascertains from the new customer whether the customer is already a member of the referral reward program. If not, then at step 304 the merchant enquires whether the customer wishes to join the program. If the customer does not wish to join the program, then the process ends 306. The customer can still make normal purchases with the merchant, without becoming a member of the referral reward program.

If the customer does wish to join the program, then a sign-up procedure 400 is followed, which is described in greater detail below with reference to FIG. 4. The outcome of the sign-up procedure 400 is that a customer account record is created within the referral reward system server databases, and the customer is issued with a unique customer identification code. The customer is then immediately able to begin obtaining the benefits of participation in the referral reward program.

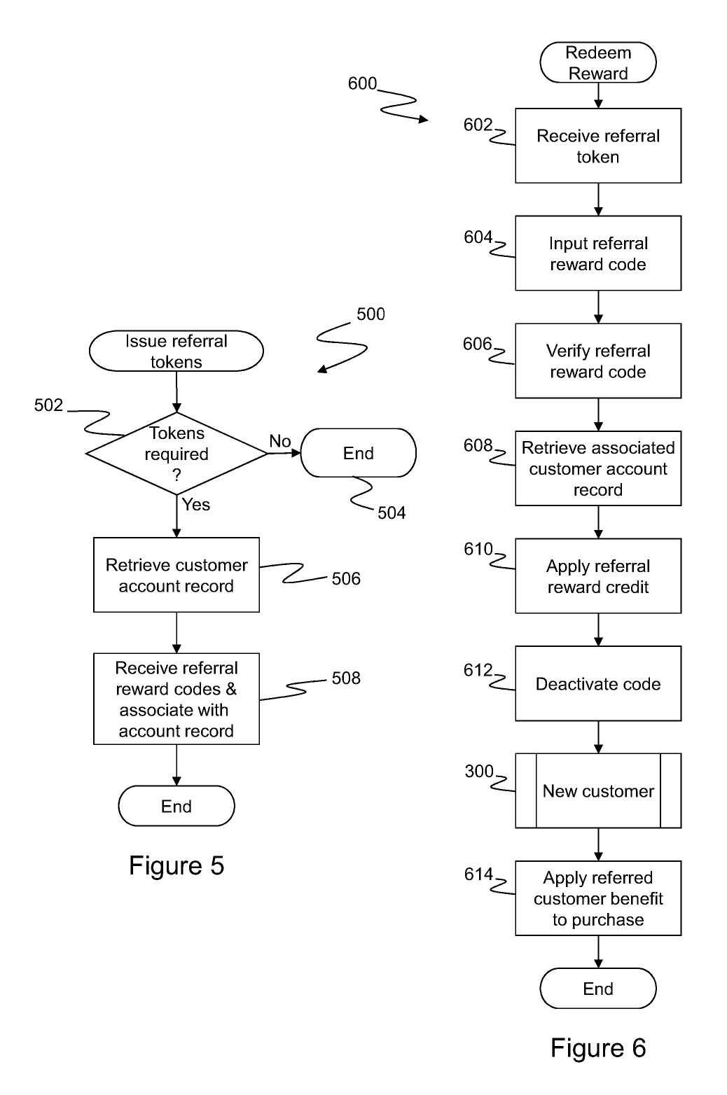

A newly enrolled customer is then issued with one or more referral tokens, at step 500, the details of which are described in greater detail below with reference to FIG. 5. Referral tokens are uniquely identifiable gift cards, or the like, which the customer may use, as a primary customer, when referring others to the merchant. When a referred customer presents a referral token to the merchant, a process is followed which is described in greater detail below with reference to FIG. 6.

The sign-up process 400 is illustrated by the flowchart in FIG. 4. At step 402, a customer account record is created for the new customer. This generally involves the referral reward system server 104 presenting a suitable customer details form via the merchant computer 106, whereby the merchant enters customer details, such as name, contact details, and other personal information, which are stored within a new customer account record within the referral reward system server databases, at step 404.

The sign-up process 400 also includes, at step 406, the issue of a unique customer identification code, which is associated with the customer account record. In one embodiment, unique customer identification codes are pre-assigned to member tokens, for example plastic cards on which the codes are printed, and/or encoded on a magnetic strip or the like, which are provided in advance to the merchant. The step 406 of issuing a customer identification code then comprises supplying the new customer with an unallocated program card, and entering the associated identification code into the customer account record via the interface presented on the merchant computer 106.

A process 500 for issuing referral tokens is illustrated by the flowchart in FIG. 5. At step 502, the merchant determines whether the customer requires any referral tokens. A customer will generally require referral tokens upon first enrolment within the referral reward program, upon first visiting a new merchant which is a member of the program, and/or upon use of all or most of their existing referral tokens for a particular merchant.

It should be understood that the referral tokens are specific to each particular merchant participating in the referral reward program. If the customer does not require any new referral tokens for the merchant, then the process 500 ends 504.

When issuing new referral tokens to the customer, the merchant accesses the referral reward system server 104 via the merchant computer 106, in order to retrieve the corresponding customer account record, at step 506. This involves entering the customer's unique customer identification code, which may be done manually, by scanning a barcode or similar printed code on a reward program card, or by swiping to read a magnetic strip of the card. Other forms of storage, such as a smart card chip, are also possible.

Once the customer account record has been retrieved, additional referral reward codes are entered and associated with the customer account record at step 508. In an embodiment of the invention, referral tokens comprise printed cards, each of which identifies the merchant to which they have been supplied, and includes a predetermined unique referral reward code. Referral tokens may be issued in groups, and the referral reward system server may be programmed such that the entry of a single referral reward code from within a group is sufficient to associate all of the referral tokens, and their associated codes, with the customer account records.

Once the referral reward codes have been associated with the customer account record, a subsequent presentation of the corresponding referral token by a referred customer enables the primary customer who provided the referral to be identified, and rewarded accordingly.

The process of a referred customer redeeming a reward is illustrated by the flowchart 600 in FIG. 6.

At step 602, the merchant receives a referral token. For example, a new customer may enter a merchant's premises, bearing a gift card or other referral token which has been supplied by a primary customer.

At step 604, the merchant uses a merchant computer 106 to access the referral reward system server 104, and enters the referral reward code associated with the referral token, at step 604. At step 606 the referral reward system server verifies the referral reward code, which may comprise confirming that the referral reward code is valid, that it is associated with the merchant entering the code, and that it has not been previously redeemed.

At step 608, the customer account records associated with the referral reward code is identified and retrieved. At step 610 the referral reward system server 104 applies a referral reward credit to the primary customer account record. The referral reward credit may be, for example, points and/or a monetary amount redeemable for future goods and/or services with the merchant to whom the primary customer has referred the new customer bearing the referral token. The credit is applied to the primary customer's account, and is subsequently available for review via an on-line interface, and for redemption with the merchant.

At step 612 the referral reward system server 104 deactivates the referral reward code, to ensure that it is not reused either intentionally, or inadvertently.

Since the referred customer is a new customer to the merchant in question, the next step in the process 600 is generally that the merchant enquires as to whether the new customer wishes to participate in the referral reward program themselves, by following the new customer process 300.

In embodiments of the invention, an incentive is provided to referred customers to take advantage of the referral, in the form of a referred customer benefit, such as a discount, applied to a first purchase. Accordingly, at step 614 this referred customer benefit is applied by the merchant.

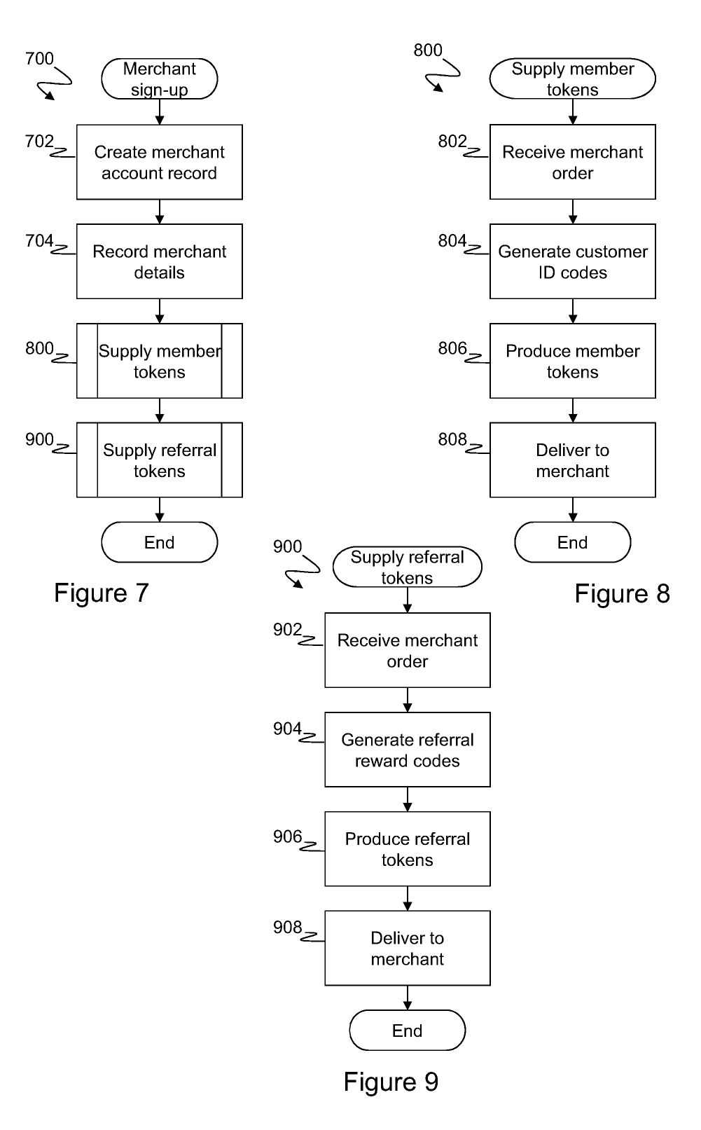

Turning now to FIGS. 7 to 9, a number of processes are illustrated referring to the relationship between a merchant and the operator of the referral reward program.

In particular, in order to participate in the referral reward program, merchants must be enrolled, supplied with member tokens (e.g. membership cards), and with referral tokens (e.g. gift cards).

The flowchart 700 in FIG. 7 illustrates the merchant sign-up process. At step 702 a merchant account record is created within the databases of the referral reward system server 104. At step 704, merchant details are recorded within the newly created record. These details may include the name or trading name of the merchant company, details of a primary contact at the merchant company, account and payment details, and details of any further employees, other than the primary contact, who may require access to the services provided by the referral reward system server 104.

Once all of the merchant details have been entered, and a merchant account created, the merchant is supplied with new member tokens at step 800, which may be issued to new customers joining the referral reward program, and at step 900 with referral tokens, which may be issued to enrolled customers for referral of new customers.

Further details of the member token supply process 800 are illustrated in the flowchart of FIG. 8. In an embodiment of the invention, merchants are required to order, and pay for, new member tokens, such as membership cards. At step 802, the operator of the referral reward system receives a merchant order for new member tokens. Orders may generally be placed via the merchant computer 106 through an interface provided by the referral reward system server 104.

At step 804, the program operator systems generate a new set of unique customer identification codes. New codes may be allocated sequentially, randomly, or according to some suitable algorithm. The important characteristic of the customer identification code is that each new code generated is unique, such that no two customers who are enrolled within the referral reward program will have the same identifier.

At step 806, a set of new member tokens, e.g. membership cards, is created bearing the newly-generated customer identification codes. As previously mentioned, the codes may be printed in a human-readable form on the tokens, may be encoded, such as in a physical barcode, QR code or the like, and/or may be encoded on a magnetic strip, or in an embedded chip. These enable the customer identification code subsequently to be entered, either manually or automatically, at the point-of-sale merchant premises.

Finally, at step 808, the newly-produced member tokens are delivered to the merchant.

FIG. 9 shows a flowchart illustrating a process 900 for the supply of new referral tokens. At step 902, the operator of the referral reward program receives an order from a merchant for the supply of additional referral tokens. An order may be placed, for example, via the merchant computer 106 using a suitable interface provided by the referral reward system server 104. In an embodiment of the invention, the merchant is required to pay for each batch of referral tokens supplied.

At step 904, a corresponding series of referral reward codes is generated. Each such code is preferably universally unique, or at least unique to the particular merchant. Suitable codes may be generated sequentially, randomly, or by any suitable algorithm, so long as the uniqueness requirement is satisfied. At step 906, a new batch of referral tokens bearing the generated referral reward codes is produced. Referral tokens may be cards, for example made of paper or cardboard, bearing human-readable and/or encoded forms of the referral reward codes. At step 908, the newly-produced referral tokens are delivered to the merchant.

The foregoing description referring to FIGS. 1 to 9 describes all of the major features of the referral reward program method and system embodying the invention. Additional features may also be provided, to provide additional value and benefits to merchants and customers, some of which will now be described.

An additional set of features may be provided to facilitate management by merchants of their own accounts within the referral reward system. In addition to account creation, merchants may be permitted to sign-up one or more employees within the referral reward system databases, such that each employee is allocated a unique employee identifier, which is associated with further employee details, such as the employee name, within corresponding records in the database.

Individual employees may be assigned different privileges for access to features of the referral reward system server 104. Access privileges which may be assigned may include: the ability to sign the merchant into the system; the ability to perform administrative functions on behalf of the merchant; the ability to edit details within merchant and/or employee records; the ability to order new member tokens and/or referral tokens; the ability to authorise payments to the referral reward program service provider; and the ability to view other information made available by the system. It will be appreciated that this is not necessarily an exhaustive list of access privileges that may be provided.

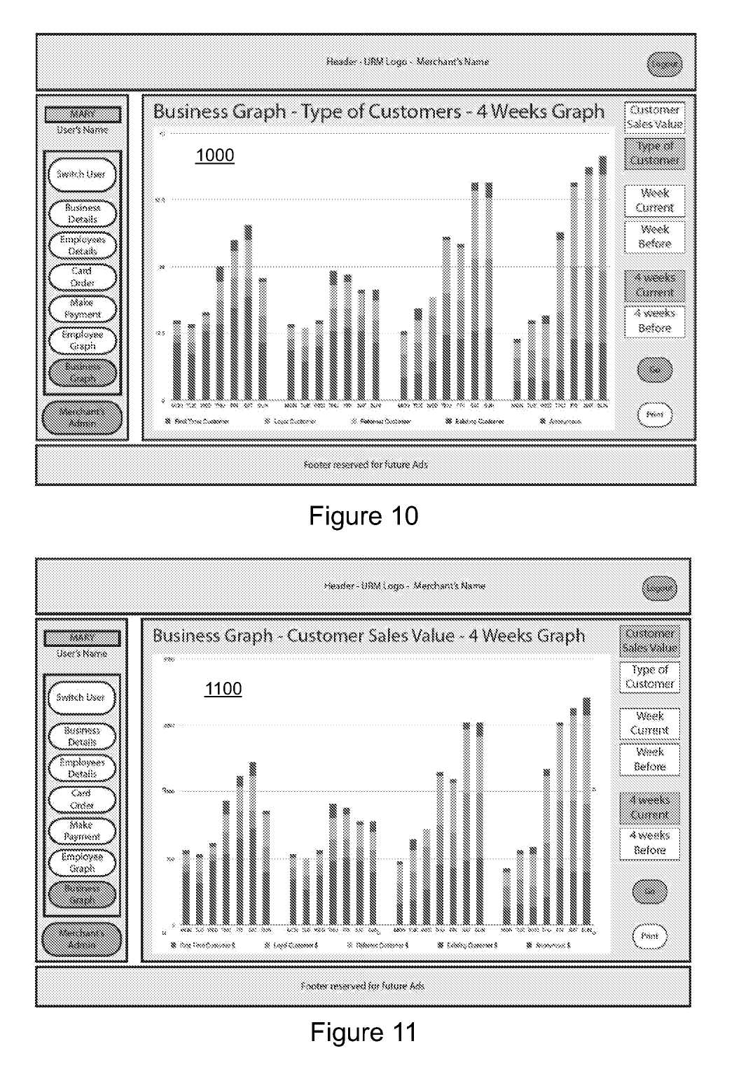

A benefit of having individual employee sign-in to the system, is that individual employee performance in relation to sales and the referral reward program may then be tracked. In general, the referral reward system server 104 may be programmed to maintain records of all transactions entered into the system, including the issuing of tokens, sales to customers, and redemption of referral tokens. FIGS. 10 to 12 are schematic screen images illustrating some of the analytics that may be provided using data recorded within the system server 104.

FIG. 10 is a screen display 1000 illustrating customer type analytics. Customers who make purchases with the merchant are categorised by the system as first-time customers, loyal customers, referred customers, existing customers, or anonymous. A first-time customer is one who has never made a purchase from the merchant previously, whether or not the customer is a member of the referral reward program. A loyal customer is a customer recorded in the system as providing a relevant level of repeat business. A referred customer is a first-time customer who has been referred by a primary customer, and who presented a referral token when making a purchase. An existing customer is a customer nominated by the merchant, which enables the system to recognise loyal customers already known to the merchant at the time of joining the program, and to avoid treating them as first-time customers. Finally, an anonymous customer is one whose identity is unknown, because they have not elected to join the referral reward program.

In the analytics display 1000 the number of customers in each category is displayed on a daily basis over four weeks. This type of data enables the merchant to assess the performance of the referral reward program, in terms of the breakdown of new business, repeat business, and referral business, generated through participation in the program.

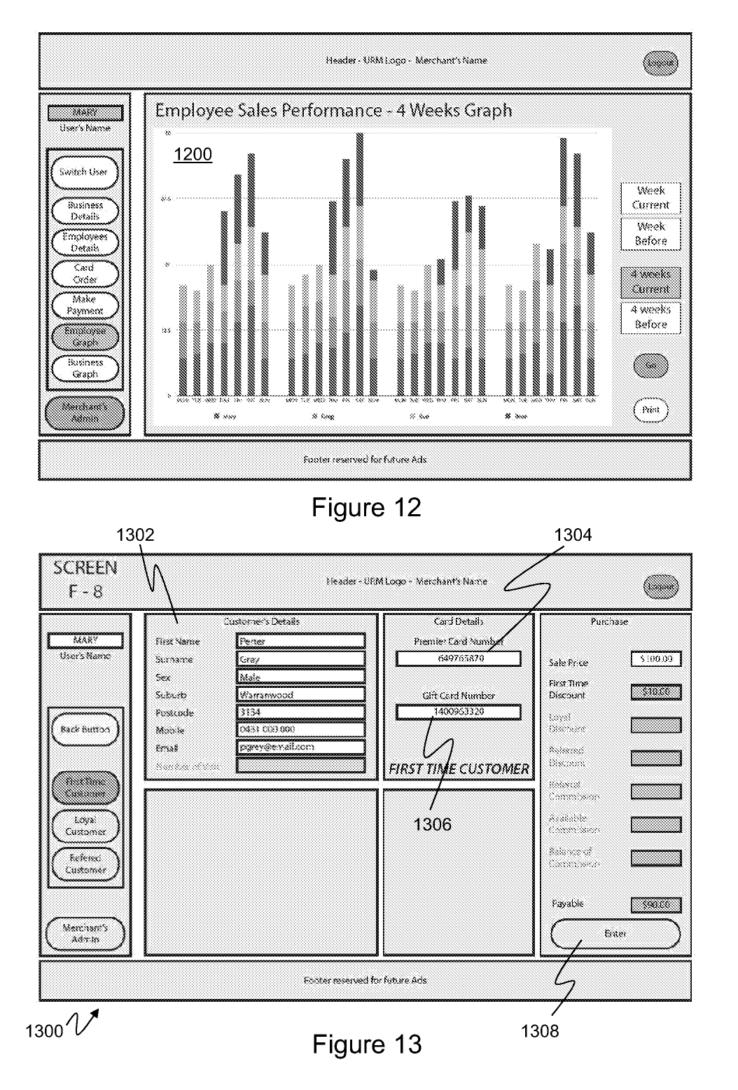

FIG. 11 is a display screen 1100 which shows equivalent analytics for customer sales value on a daily basis, broken down by customer type, over a four-week period. Individual customers may make low- or high-value purchases, and analytics of this type enable the merchant to obtain an overview of which types of customer provide the highest value over time. The exemplary display 1200 shown in FIG. 12 provides analytics of employee sales performance, over a four-week period. These charts enable the merchant to review and compare the performance of each employee, in terms of the value of sales made.

In addition to the information made available to the merchant, the referral reward system server 104 may also provide an interface for use by customers, which may be accessible via the Internet 102 from a customer client computer 108 or a mobile device 110. In an exemplary embodiment, a customer is able to log into a web-based system using their unique customer identification code as provided on their membership card, along with a password, or other security identifier. The customer may then be enabled to review the history of purchases and rewards, including details of purchases at each participating merchant, the number of successful referrals, and the value of any referred customer benefits accumulated with particular merchants, as a result of successful referrals.

Turning now to FIGS. 13 to 18, examples are provided of a number of the user interface screens implemented by the referral reward system server 104 to enable the entry and retrieval of customer and merchant information.

FIG. 13 is an exemplary screen 1300 used by a merchant to enrol a new customer in the referral reward program. The screen 1300 provides text-entry boxes 1302 for entry of the new customer details. A text-entry box 1304 is provided for the input of the unique customer identification code associated with a new membership card issued by the merchant to the customer. A further text-entry box 1306 is provided for entry of a referral token identification code. As previously mentioned, the codes in the text boxes 1304 and 1306 may be automatically entered, for example via a barcode scanner or magnetic-strip reader. Once all information has been input, pressing the enter button 1308 results in the information being sent to the referral rewards system server 104, to enable creation of the new customer record.

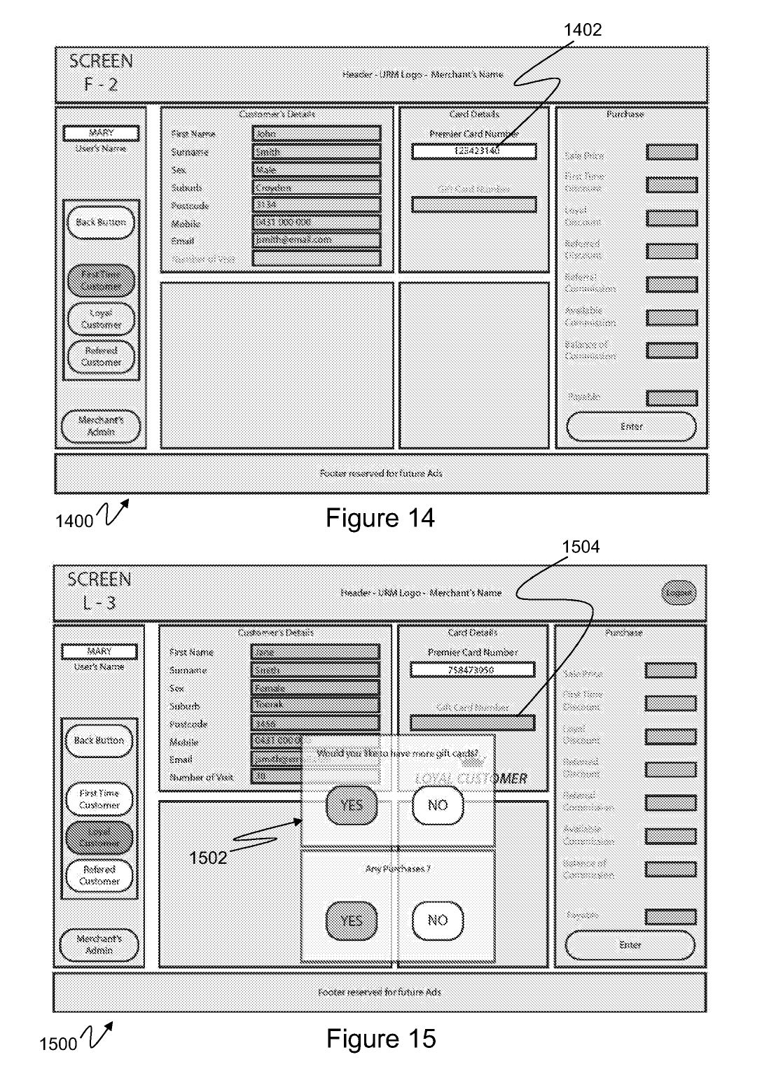

The screen 1300 applies when a new customer is also a new member of the referral reward program. An alternative screen 1400, shown schematically in FIG. 14, may be provided for use by merchants when a first-time customer is already a member of the referral reward program. In this case, there is no need to enter all of the customer details, and only the unique customer identifier, as printed on the customer's membership card, is required to be input to the entry box 1402. All of the customer details can then be retrieved using this unique identifier from the databases of the referral reward system server 104.

A further screen 1500 is illustrated schematically in FIG. 15, which may be presented to the merchant when a customer, identified by entry of their unique customer identification code, is an existing and loyal customer. Since loyal customers are more likely to refer other business, the system presents a dialogue box 1302 requesting whether or not the customer requires additional referral tokens, e.g. gift cards. If the answer is ‘yes’, then the entry box 1304 becomes available for the merchant to enter the unique identifiers of new referral tokens issued to the loyal customer.

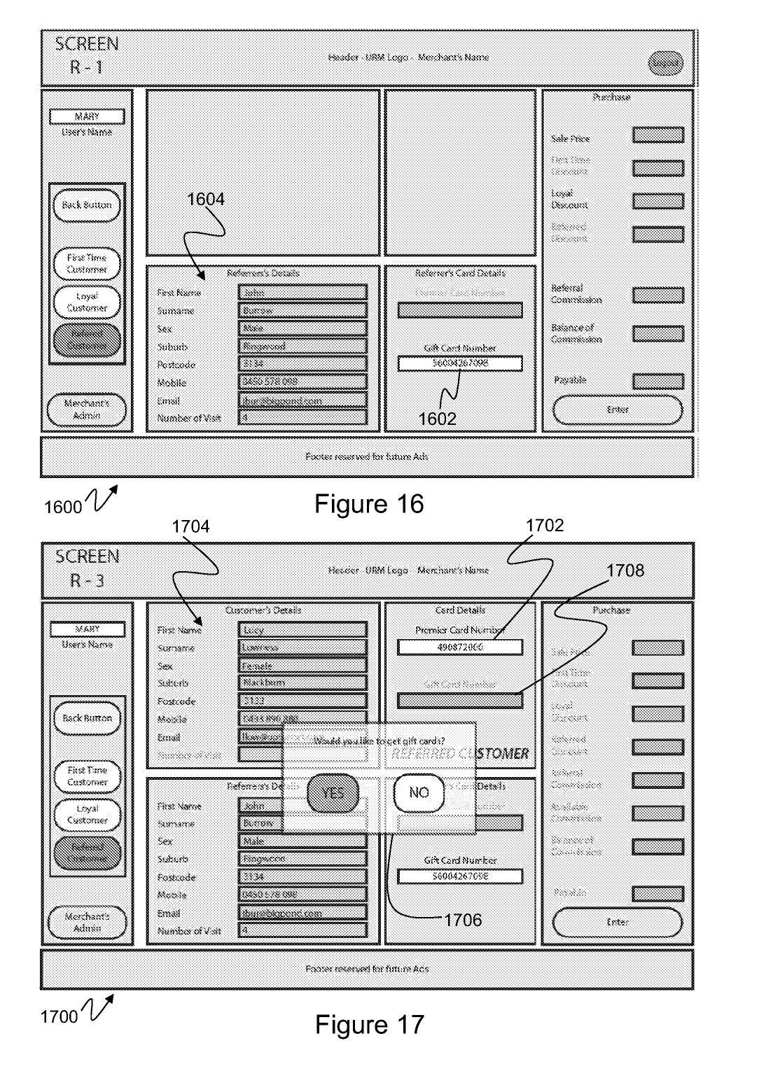

FIG. 16 shows schematically a screen 1600 which may be used by a merchant when a new referred customer presents a referral token. The unique code associated with the referral token is input into the entry box 1602, whereby it is transmitted to the referral reward system server 104. The server 104 then identifies and retrieves the primary customer record with which the referral reward code is associated. Details of the referring customer are provided in the text boxes 1604.

FIG. 17 shows schematically an exemplary screen 1700 corresponding to a case in which the referred customer is already a member of the referral reward program. The referred customer's existing unique identifier is input to the text entry box 1702, and the customer details 1704 retrieved. Since this is the referred customer's first visit to this particular merchant, the system presents a dialogue box 1706 to ask whether the referred customer requires referral tokens, e.g. gift cards, for the particular merchant. If so, then the corresponding text-entry box 1706 becomes available, for input of one or more issued referral reward codes.

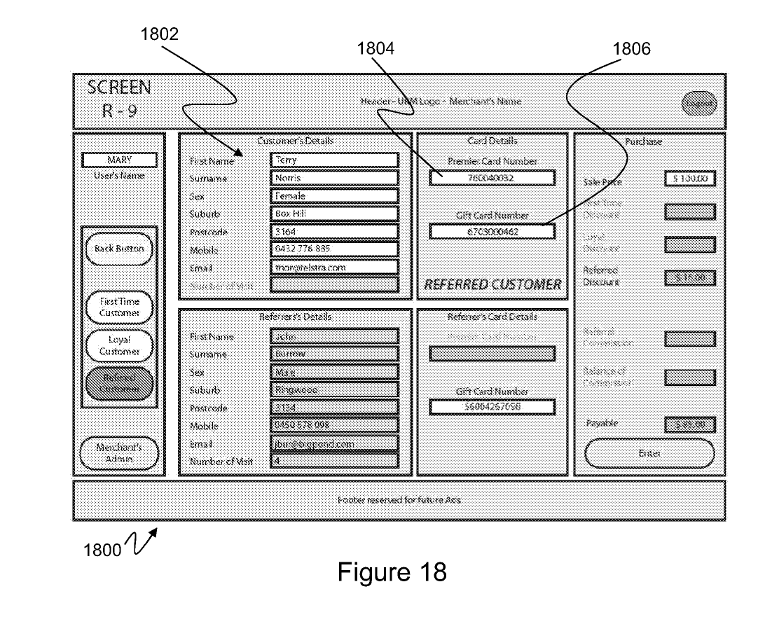

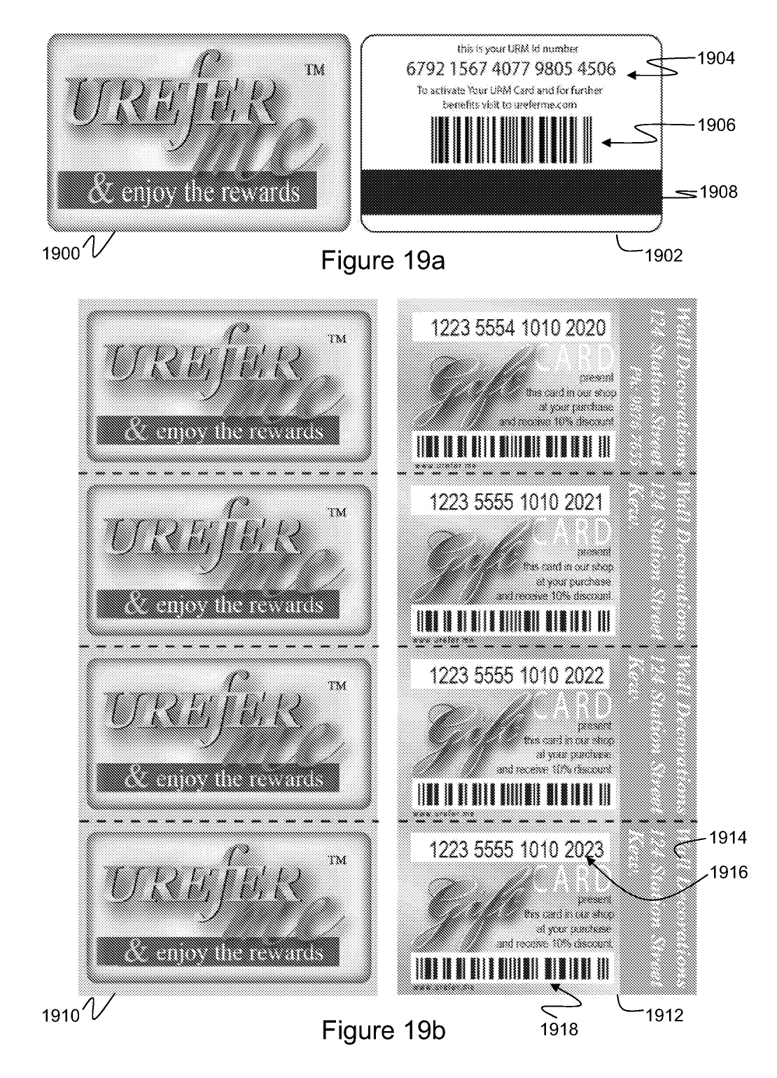

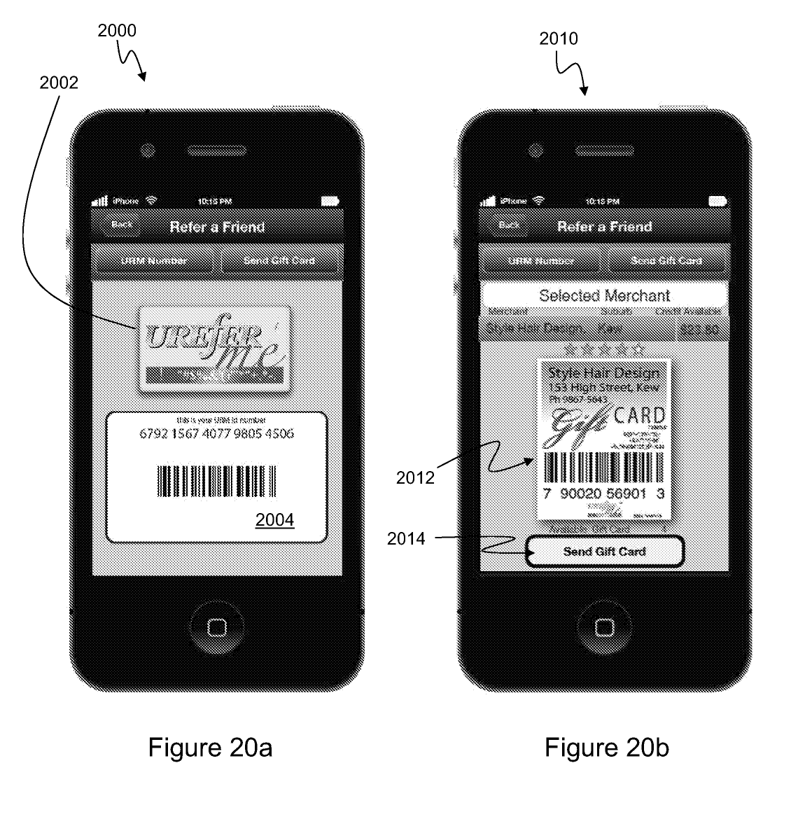

The screen 1800 shown schematically in FIG. 18 illustrates a case in which a referred customer is not an existing member of the referral reward program, and may be provided with an option to enroll. As with the new customer sign-up screen 1300, provision is made for entry of the referred customer details 1802, entry of a newly-allocated customer identification code 1804, and entry of a newly issued referral reward token, e.g. gift card, identifier 1806.

While the exemplary merchant interface screens shown in FIGS. 13 to 18 are not intended to provide an exhaustive catalogue of all functionality provided within the referral reward system, they represent an illustrative subset of the system functions. As will be appreciated by those skilled in the relevant art of computer programming, various additional functionality can be provided, which falls within the scope of the present invention.

FIG. 19A illustrates an exemplary member token, in the form of a conventional plastic card, for example a wallet-sized card similar to a credit card. The front side of the card 1900 bears branding of the referral reward program. On the rear of the card 1902 the unique customer identification code is printed in a human-readable format 1904, a machine-readable format (i.e. barcode) 1906, and is additionally encoded on a magnetic strip 1908. Methods for the manufacture of such cards are well-known, and details are therefore not provided within this specification.

FIG. 19B illustrates a group of four referral tokens, or gift cards, which are generally issued to a customer as a single unit. The front sides of the cards 1910 bear the referral reward program branding. The rear sides of the cards 1912 bear information identifying the merchant 1914, and the associated unique referral reward code in a human-readable form 1916 and a machine-readable (barcode) form 1918. The referral tokens may be printed on any suitable material, e.g. heavy paper or cardboard.

In some embodiments it may be possible to operate the program in a paperless fashion, for example by issuing member tokens and referral tokens in electronic form. In one such embodiment the tokens are distributed via mobile electronic devices, such as smart phones 110. As will be appreciated by persons skilled in the relevant art of computer programming, modern smart phones are able to access the Internet and to execute mobile browser software, providing one simple mechanism to implement electronic tokens. Alternatively, a specific app may be developed, downloaded and installed on a customer smart phone for managing the customer's tokens.

A member token screen of such an exemplary smart phone app is illustrated at 2000 in FIG. 20A. The screen 2000 comprises the same branding information 2002 and customer identification code 2004 as the physical token illustrated in FIG. 19. This information can also be used by the merchant in the same manner, i.e. the customer identification code may be manually entered, or scanned using a barcode scanner.

FIG. 20B illustrates a further exemplary app screen display 2010 which enables a primary customer to issue a referral token to a referred customer. Referral tokens are provided in electronic form, and records of available tokens are maintained by the referral reward system server 104 and the smart phone 110. As illustrated in the screen 2010, the customer is able to retrieve a stored token, which is displayed as an image 2012 on the smart phone display, and has the option, by pressing the button 2014, to send the referral token (gift card) to a referred customer. Sending of the referral token may be via any mechanism supported by the smart phone 110, such as MMS messaging, or email. Once received by the referred customer, the same image of the referral token 2012 may be displayed on the referred customer's handset, so that the corresponding unique referral reward code may be read, either by a human operator or by a barcode scanner.

While not a core element of the invention, the operator of the referral reward system may charge for the services provided in a number of different ways. In one particular embodiment, fees are levied for the issue of new member tokens and referral tokens. Additionally, fees may be levied when tokens are actually issued to customers. For business reasons, a preferred commercial strategy is to levy fees only when the merchant's participation in the referral reward program results in actual sales. This includes, for example, levying fees, such as a percentage of a sale, upon a purchase made by a loyal customer in association with the referral reward program.

However, as will be appreciated, a number of profit, and not-for-profit strategies may be employed in the operation of a referral reward system as generally described herein.

While particular embodiments have been described, by way of example only, a person skilled in the relevant art will appreciate that a number of variations are possible, within the scope of the present invention, which is as define din the claims appended hereto.

1. A method of operating a referral reward program between a merchant, a primary customer and a referred customer, the method comprising steps of:
providing a database for storage of customer account records;
issuing to the primary customer a customer identifier code, and storing details of the primary customer in a customer account record in the database in association with the customer identification code;
issuing to the primary customer at least one referral token associated with the merchant, the token having a corresponding referral reward code;
associating the referral reward code with the primary customer account record in the database;
subsequently receiving the referral reward code provided by the referred customer;
using the referral reward code to retrieve the associated primary customer account record; and
updating the primary customer account record to apply a referral reward credit subsequently redeemable with the merchant by the primary customer.

2. The method of claim 1 comprising the step of issuing a member token to the primary customer, wherein the member token is associated with the customer identifier code.

3. The method of claim 2 wherein the member token is a card, and the customer identifier code is recorded on or in the card.

4. The method of claim 1 wherein the referral token is a card, and the referral reward code is recorded on or in the card.

5. The method of claim 2 wherein the member token is a digital object suitable for storage and display on a mobile device of the primary customer, and the customer identifier code is stored in the member token digital object.

6. The method of claim 1 wherein the referral token is a digital object suitable for storage and display on a mobile device of the primary customer and for transmission to a mobile device of the referred customer and the referral reward code is recorded in the digital object.

7. The method of claim 1 wherein the referral reward code is provided by the referred customer presenting the referral token to the merchant, and comprising the further step of the merchant providing a referred customer benefit to the referred customer.

8. The method of claim 1 comprising a further step of deactivating the referral reward code within the database to prevent reuse.

9. The method of claim 1 wherein the database is further provided for storage of merchant account records, and the method further comprises:
associating the customer identifier code of the primary customer in the database with a merchant account record of the merchant; and
maintaining records of customer activity with the merchant in the merchant account record.

10. The method of claim 1 further comprising the steps of the primary customer redeeming the referral reward credit, and recording the redemption in the database.

11. The method of claim 1 further comprising the step of providing an online web or mobile access interface enabling the primary customer to review details of the primary customer account record, including available credit.

12. A computer-implemented system for operating a referral reward program between a merchant, a primary customer and a referred customer, the system comprising:
at least one microprocessor;
at least one non-volatile storage device containing a database for storage of customer account records;
at least one computer-readable memory device operatively associated with the microprocessor; and
at least one user input device operatively associated with the microprocessor,
wherein the memory device contains computer executable instruction code which, when executed by the microprocessor, cause the microprocessor to effect a method comprising steps of:
receiving a customer identifier code issued to the primary customer, and receiving and storing details of the primary customer in a customer account record in the database in association with the customer identification code;
receiving a referral reward code corresponding with at least one referral token associated with the merchant, wherein a referral token corresponding with the referral reward code has been issued to the primary customer;
associating the received referral reward code with the primary customer account record in the database;
subsequently receiving the referral reward code provided by the referred customer;
using the referral reward code to retrieve the associated primary customer account record; and
updating the primary customer account record to apply a referral reward credit subsequently redeemable with the merchant by the primary customer.

13. The system of claim 12 wherein the computer executable instruction code further causes the microprocessor to effect a step of deactivating the referral reward code within the database to prevent reuse.

14. The system of claim 12 wherein the database is further provided for storage of merchant account records, and the computer executable instruction code further causes the microprocessor to effect steps of:
associating the customer identifier code of the primary customer in the database with a merchant account record of the merchant; and
maintaining records of customer activity with the merchant in the merchant account record.

15. The system of claim 12 wherein the computer executable instruction code further causes the microprocessor to effect the step, when the primary customer redeems the referral reward credit, of recording the redemption in the database.
